(19) United States
(12) Patent Application Publication
(10) Pub. No.: US 2009/0129789 A1
(43) Pub. Date: May 21, 2009

(54) Method and Apparatus for Extracting Clock Signal From Optical Signal

(76) Inventor: Masanori Hanawa, Yamanashi (JP)

Correspondence Address: BIRCH STEWART KOLASCH & BIRCH, PO BOX 747, FALLS CHURCH, VA, 22040-0747, US

(21) Appl. No.: 11/988,145

(22) PCT Filed: Feb. 10, 2006
(86) PCT No.: PCT/JP2006/302785

§ 371 Date: Dec. 31, 2007

(30) Foreign Application Priority Data
Jul. 1, 2005 (JP) 2005-194117
Sep. 6, 2005 (JP) 2005-257778

(51) Int. Cl. H04B 10/06

(52) U.S. Cl. 398/214

(57) ABSTRACT

A clock extraction apparatus capable of supporting even a high-speed optical signal with a simple arrangement is proposed. A π-phase shifted fiber Bragg grating (π-phase shifted FBG) 10 is adjusted in such a manner that a phase difference between reflected light waves resulting from two sub-FBGs 1 and 2 will be π and time delay Δt between the reflected light waves will be smaller than the bit period T_{b} of an optical signal. An optical signal is input to the π-phase shifted FBG. Pulses are produced in a reflected light wave that is output from the π-phase shifted FBG 10, the pulses appearing at rising and falling edges of an NRZ signal. The reflected light wave is passed through a light circulator 11 and is converted to an electrical signal by a photosensor 12. A clock signal is generated (produced) by passing the electrical signal into a narrow-band filter 13. Using a low-reflectivity Bragg grating-loaded π-phase shifted Bragg grating having four sub-FBGs 1 to 4 improves resistance to wavelength drift in clock signal extraction.

### TECHNICAL FIELD

This invention relates to an apparatus and method for extracting a clock signal from an optical signal. More particularly, the invention relates to a method and apparatus for extracting a clock signal from an on-off keying NRZ (OOK-NRZ) optical signal generally used in an optical fiber communication system.

### BACKGROUND ART

Clock extraction is an essential technique as far as communication systems are concerned. In a case where the basic pulse waveform is a rectangular pulse in an on-off keying NRZ (OOK-NRZ) (NRZ: Non-Return-to-Zero) optical signal (referred to as an “NRZ optical signal” below) generally used in optical fiber communication systems, in principle the signal does not have a clock component and direct extraction of a clock from the NRZ optical signal cannot be performed. On the other hand, in the case of NRZ optical signals actually used, the basic pulse waveform is not an ideal rectangular pulse. The signal therefore has a very weak clock component and clock extraction by electrical processing is possible for transmission speeds up to several tens of gigabits per second (Gb/s). However, the clock-to-modulation component ratio is low and there is the danger of a decline in the S/N ratio of the extracted clock signal and of an increase in jitter. Furthermore, in the case of a high-speed NRZ optical signal greater than 100 Gb/s, it is not possible to perform clock extraction with electrical processing. For this reason, various methods of making clock extraction possible in combination with use of optical signal processing are being studied.

For example, the following literature has been reported: M. L. Nielsen, J. D. Buron, J. Mork and B. Dagens, “All-optical Extraction of 40 GHz component from 40 Gb/s NRZ data using Signal Processing in an SOA combined with optical filtering”, Technical Digest of OECC/COIN 2004, 16E3-3, pp. 884-885, July 2004.

This literature proposes a method of utilizing a non-linear optical effect in a semiconductor optical amplifier (referred to as an “SOA” below), generating a pseudo-RZ signal at the rising or falling edge of an NRZ optical signal that has been input to the SOA, and extracting a clock from a 40-Gb/s NRZ optical signal by cutting out only the clock component using a narrow-band filter for electrical signals. Although this method makes it possible to deal with a high-speed NRZ optical signal that exceeds 100 Gb/s, using a semiconductor optical amplifier solely for clock extraction is too expensive.

### DISCLOSURE OF THE INVENTION

The present invention provides a clock signal extraction method and apparatus capable of supporting optical signals of higher speeds with a simple arrangement.

The present invention further provides a clock signal extraction method and apparatus of improved resistance to wavelength drift in clock extraction.

A clock signal extraction method according to the present invention comprises steps of: using a π-phase shifted Bragg grating, which has two Bragg gratings disposed in an optical waveguide with a gap interposed between them, adjusted in such a manner that a phase difference between reflected light waves resulting from the two Bragg gratings will be π and amount of time delay between the reflected light waves will be Δt; guiding an optical signal from which a clock signal is to be extracted to the π-phase shifted Bragg grating, taking out a reflected light wave from the π-phase shifted Bragg gratings and converting the reflected light wave to an electrical signal; and obtaining a clock signal by passing this electrical signal into a narrow-band filter in which a frequency corresponding to the reciprocal of the bit period (T_{b}) of the optical signal is adopted as the pass central frequency.

In an embodiment, the above-described clock signal extraction method uses π-phase shifted Bragg gratings in which, of the two Bragg gratings, optical-path length of a Bragg grating on the side on which the optical signal from which the clock signal is to be extracted impinges and optical-path length of the gap delimited by the two Bragg gratings are adjusted in such a manner that the time delay Δt between the reflected light waves will be smaller than the bit period T_{b} of the optical signal from which the clock signal is to be extracted.

In a preferred embodiment, reflectivities of the respective two Bragg gratings are decided in such a manner that the intensities of the reflected light waves of the two Bragg gratings will be substantially the same.

A clock signal extraction apparatus according to the present invention comprises: a π-phase shifted Bragg grating, which has two Bragg gratings disposed in an optical waveguide with a gap interposed between them, adjusted in such a manner that a phase difference between reflected light waves resulting from the two Bragg gratings will be π and amount of time delay between the reflected light waves will be Δt; a light circulator for guiding an optical signal from which a clock signal is to be extracted to the π-phase shifted Bragg grating and outputting a reflected light wave from the π-phase shifted Bragg grating; a photosensor for converting the reflected light wave, which is output from the light circulator, to an electrical signal; and a narrow-band filter, which is connected to an output side of the photosensor, for adopting a frequency corresponding to the reciprocal of the bit period (T_{b}) of the optical signal as the pass central frequency.

In an embodiment, the π-phase shifted Bragg gratings are such that, of the two Bragg gratings, optical-path length of a Bragg grating on the side on which the optical signal from which the clock signal is to be extracted impinges and optical-path length of the gap delimited by the two Bragg gratings are adjusted in such a manner that the time delay Δt between the reflected light waves will be smaller than the bit period T_{b} of the optical signal from which the clock signal is to be extracted.

In a preferred embodiment, reflectivities of the respective two Bragg gratings are decided in such a manner that the intensities of the reflected light waves of the two Bragg gratings will be substantially the same.

In a preferred embodiment, the grating period of the two Bragg gratings is decided in such a manner that the Bragg wavelengths of the two Bragg gratings will be substantially the same.

In an embodiment, the optical waveguide is an optical fiber.

In another embodiment, the optical waveguide is a plane optical waveguide.

Although the present invention is applicable to a fiber Bragg grating (referred to as an “FBG” below) in which a Bragg grating has been formed in the core of an optical fiber, and to a device in which a Bragg grating has been formed in a plane optical waveguide, the present invention is explained below taking the FBG as an example.

In accordance with the present invention, use is made of a π-phase shifted fiber Bragg grating (referred to as a “π-phase shifted FBG” below). The π-phase shifted FBG has two sub-fiber Bragg gratings (referred to as “sub-FBG” below). An optical signal from which a clock is to be extracted is introduced to the π-phase shifted FBG. In the π-phase shifted FBG, a time delay (Δt) [smaller than the bit period (T_{b}) of the optical signal] and a phase difference of π are applied in the gap of the π-phase shifted FBG between reflected light of the sub-FBG of a preceding stage and reflected light of the sub-FBG of the succeeding stage. That is, the π-phase shifted FBG functions as a differential unit. In the output optical signal (an optical signal that is the result of combining the two reflected light waves) obtained from the π-phase shifted FBG, the reflected light waves from the respective sub-FBGs interfere and cancel each other out in the temporally overlapping portions owing to the phase difference π between the reflected light waves. Light pulses having a pulse width corresponding to the time delay (Δt) appear at the rising edge and falling edge of the optical signal (e.g., NRZ optical signal) from which a clock is to be extracted. The amplitude of the light pulse at the falling edge is negative if the light pulse at the rising edge is considered as the reference, since the light pulse at the falling edge differs in phase by π with respect to the light pulse at the rising edge. These light pulses are converted to an electrical signal by a photosensor, whereby there is obtained an electrical signal (referred to as a “pseudo-RZ signal”) in which the polarity of the light pulse of negative amplitude that appears at the falling (trailing) edge becomes positive. Since this electrical pulse signal has pulses at the positions of the rising and falling edges of the original optical signal (NRZ optical signal), the pulse interval is an integral multiple of the bit period (T_{b}) of the original optical signal (the minimum interval is T_{b}), and the signal has a strong clock component. By passing this electrical signal through a narrow-band filter, the clock component of the original NRZ optical signal can be extracted (this represents clock extraction).

In accordance with the present invention, as described above, a strong clock signal can be extracted since the pseudo-RZ pulse density is doubled in comparison with the conventional technique described above by using a simple arrangement. Further, if the time delay (Δt) is reduced by shortening the sum of the length of the sub-FBG of the preceding stage and the length of the gap in the π-phase shifted FBG, it is possible to support an optical signal of higher speed [of shorter bit period (T_{b})].

The present invention also provides a π-phase shifted FBG ideal for use in the above-described clock extraction method and apparatus.

The π-phase shifted FBG is a Bragg grating device and has two Bragg gratings disposed in an optical waveguide with a gap interposed between them and is adjusted in such a manner that a phase difference between reflected light waves resulting from the two Bragg gratings will be π and amount of time delay between the reflected light waves will be Δt.

In an embodiment, of the two Bragg gratings, optical-path length of a Bragg grating on the side on which the optical signal from which the clock signal is to be extracted impinges and optical-path length of the gap delimited by the two Bragg gratings are adjusted in such a manner that the time delay Δt between the reflected light waves will be smaller than the bit period T_{b} of the optical signal from which the clock signal is to be extracted.

In a preferred embodiment, reflectivities of the respective two Bragg gratings are decided in such a manner that the intensities of the reflected light waves of the two Bragg gratings will be substantially the same.

In a preferred embodiment, the grating period of the two Bragg gratings is decided in such a manner that the Bragg wavelengths of the two Bragg gratings will be substantially the same.

In an embodiment, at least one of the two Bragg gratings is an apodized grating.

In another embodiment, the optical waveguide is an optical fiber.

In a further embodiment, the optical waveguide is a plane optical waveguide.

A clock signal extraction method of improved resistance to wavelength drift in clock extraction according to the present invention comprises the steps of: using a low-reflectivity Bragg grating-loaded π-phase shifted Bragg grating, which has first, second, third and fourth sub-Bragg gratings (FBG 1, FBG 2, FBG 3, FBG 4) disposed in an optical waveguide with gaps interposed between them, these first, second, third and fourth sub-Bragg gratings being arranged in the order mentioned and reflectivities (R1, R4) of the first and fourth sub-Bragg gratings (FBG1, FBG4) being adjusted so as to be less than reflectivities (R2, R3) of the second and third sub-Bragg gratings (FBG 2, FBG 3), an adjustment being made in such a manner that a phase difference between the reflected light waves of the first and second sub-Bragg gratings, a phase difference between the reflected light waves of the second and third sub-Bragg gratings and a phase difference between the reflected light waves of the third and fourth sub-Bragg gratings will each be π and amount of time delay Δt between the reflected light waves will be smaller than a bit period (T_{b}) of the optical signal from which the clock signal is to be extracted; guiding an optical signal from which a clock signal is to be extracted to the low-reflectivity Bragg grating-loaded π-phase shifted Bragg grating from the side of the first sub-Bragg grating, taking out a reflected light wave from the low-reflectivity Bragg grating-loaded π-phase shifted Bragg grating and converting the reflected light wave to an electrical signal; and obtaining a clock signal by passing this electrical signal into a narrow-band filter in which a frequency corresponding to the reciprocal of the bit period (T_{b}) of the optical signal is adopted as the pass central frequency.

By virtue of this arrangement, in a case where a wavelength difference Δλ arises between the carrier wavelength of an optical signal from which a clock signal is to be extracted and the Bragg wavelength of a π-phase shifted Bragg grating, the wavelength difference Δλ that is allowable increases.

In a preferred embodiment, use is made of a low-reflectivity Bragg grating-loaded π-phase shifted Bragg grating in which among the four sub-Bragg gratings, the sum (L1+L_{g1}) of the optical-path length (L1) of the first sub-Bragg grating (FBG 1) and the optical-path length (L_{g1}) of the gap delimited by the first and second sub-Bragg gratings (FBG 1, FBG 2), the sum (L2+L_{g2}) of the optical-path length (L2) of the second sub-Bragg grating (FBG 2) and the optical-path length (L_{g2}) of the gap delimited by the second and third sub-Bragg gratings (FBG 2, FBG 3) and the sum (L3+L_{g3}) of the optical-path length (L3) of the third sub-Bragg grating (FBG 3) and the optical-path length (L_{g3}) of the gap delimited by the third and fourth sub-Bragg gratings (FBG 3, FBG 4) are adjusted in such a manner that the sum of time delays Δt between the reflected waves from two mutually adjacent sub-Bragg gratings will be smaller than the bit period (T_{b}) of the optical signal from which the clock signal is to be extracted.

In a preferred embodiment, among the four sub-Bragg gratings, reflectivities (R1, R4) of the first and fourth sub-Bragg gratings and reflectivities (R2, R3) of the second and third sub-Bragg gratings are decided in such a manner that the intensities of the reflected light waves of the respective pair of two Bragg gratings will be substantially the same. That is, the reflectivities are decided in such a manner that R1=R4, R2=R3 will hold.

In a further preferred embodiment, the grating periods of the four sub-Bragg gratings are decided in such a manner that the Bragg wavelengths of these four sub-Bragg gratings will be substantially the same.

A clock extraction apparatus according to the present invention comprises: a low-reflectivity Bragg grating-loaded π-phase shifted Bragg grating, which has first, second, third and fourth sub-Bragg gratings (FBG 1, FBG 2, FBG 3, FBG 4) disposed in an optical waveguide with gaps interposed between them, these first, second, third and fourth sub-Bragg gratings being arranged in the order mentioned and reflectivities (R1, R4) of the first and fourth sub-Bragg gratings (FBG1, FBG4) being adjusted so as to be less than reflectivities (R2, R3) of the second and third sub-Bragg gratings (FBG2, FBG3), an adjustment being made in such a manner that a phase difference between the reflected light waves of the first and second sub-Bragg gratings, a phase difference between the reflected light waves of the second and third sub-Bragg gratings and a phase difference between the reflected light waves of the third and fourth sub-Bragg gratings will each be π and amount of time delay Δt between the reflected light waves will be smaller than a bit period T_{b} of the optical signal from which the clock signal is to be extracted; a light circulator for guiding an optical signal from which a clock signal is to be extracted to the low-reflectivity Bragg grating-loaded π-phase shifted Bragg grating from the side of the first sub-Bragg grating, and outputting a reflected light wave from the low-reflectivity Bragg grating-loaded π-phase shifted Bragg grating; a photosensor for converting the reflected light wave, which is output from the light circulator, to an electrical signal; and a narrow-band filter, which is connected to an output side of the photosensor, for adopting a frequency corresponding to the reciprocal of the bit period (T_{b}) of the optical signal as the pass central frequency.

Resistance to wavelength drift is heightened in this clock extraction apparatus as well.

The foregoing embodiments are applicable to this clock extraction apparatus as well.

In a further embodiment, the optical wavelength is an optical fiber. In another embodiment, the optical waveguide is a plane optical waveguide.

The present invention further provides a Bragg grating device of improved resistance to wavelength drift. Specifically, the Bragg grating device is used in the extraction of a clock signal from an optical signal, has first, second, third and fourth sub-Bragg gratings (FBG 1, FBG 2, FBG 3, FBG 4) disposed in an optical waveguide with gaps interposed between them, these first, second, third and fourth sub-Bragg gratings being arranged in the order mentioned and reflectivities (R1, R4) of the first and fourth sub-Bragg gratings (FBG 1, FBG 4) being adjusted so as to be less than reflectivities (R2, R3) of the second and third sub-Bragg gratings (FBG 2, FBG 3), an adjustment being made in such a manner that a phase difference between the reflected light waves of the first and second sub-Bragg gratings, a phase difference between the reflected light waves of the second and third sub-Bragg gratings and a phase difference between the reflected light waves of the third and fourth sub-Bragg gratings will each be π and amount of time delay Δt between the reflected light waves will be smaller than a bit period T_{b} of the optical signal from which the clock signal is to be extracted.

The foregoing embodiments are applicable to this Bragg grating device as well.

### BRIEF DESCRIPTION OF THE DRAWINGS

FIG. 1 illustrates the overall configuration of a clock signal extraction apparatus according to a first embodiment;

FIG. 2 illustrates the detailed structure of a π-phase shifted FBG;

FIG. 3 is an equivalent circuit diagram illustrating that a π-phase shifted FBG acts as a differential unit;

FIG. 4 is a waveform diagram illustrating input/output signal waveforms of each block of the apparatus shown in FIG. 1;

FIG. 5 illustrates the overall configuration of a clock signal extraction apparatus according to a second embodiment;

FIG. 6 illustrates the detailed structure of a low-reflectivity FBG-loaded π-phase shifted FBG;

FIG. 7 is an equivalent circuit diagram illustrating that a low-reflectivity FBG-loaded π-phase shifted FBG acts as a differential unit; and

FIG. 8 is a waveform diagram illustrating input/output signal waveforms of each block of the apparatus shown in FIG. 5.

### BEST MODE FOR CARRYING OUT THE INVENTION

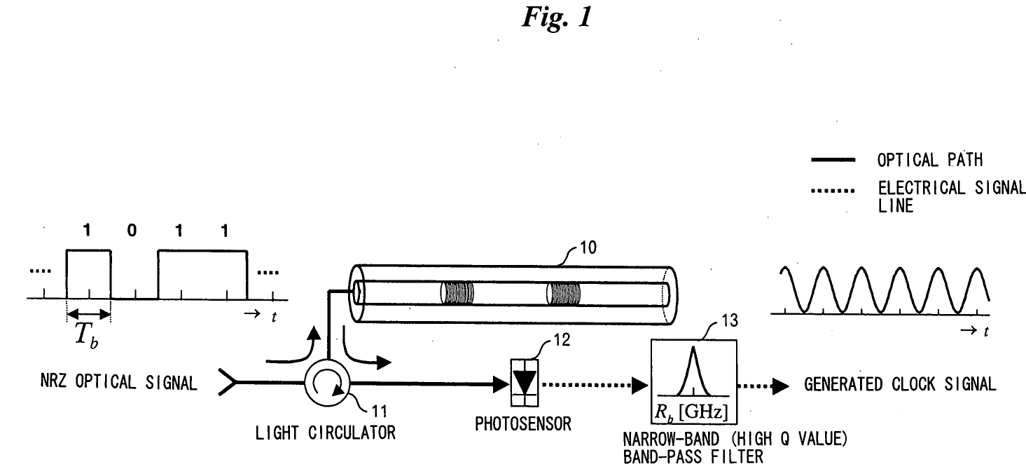

FIG. 1 illustrates the overall configuration of an apparatus according to a first embodiment for extracting (the term “generating” or “producing” may also be used) a clock signal from an NRZ optical signal.

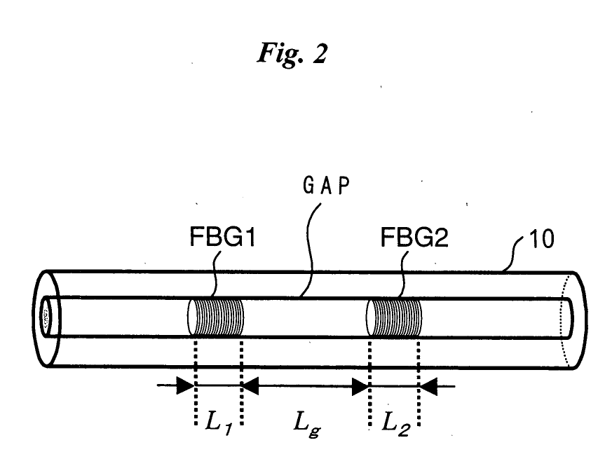

A π-phase shifted FBG (fiber Bragg grating) 10 is an optical fiber comprising a core and a surrounding clad layer. As illustrated in the enlarged view of FIG. 2, a sub-FBG 1 of a preceding stage and a sub-FBG 2 of the succeeding stage are formed in the core of the optical fiber at positions slightly inward from a light input/output end (the left end of the π-phase shifted FBG 10 shown in FIG. 2). A gap exists between the two sub-FBGs 1 and 2. The sub-FBG 1 and sub-FBG 2 are gratings (diffraction gratings) that are ascribable to a change in refractive index that produces Bragg diffraction.

The π-phase shifted FBG 10 has the following two functions:

(1) A phase difference of π exists at the Bragg wavelength λ_{b} between a reflected light wave that returns to the input/output end owing to reflection, at the sub-FBG 1 of the preceding stage, of a light wave that has entered from the input/output end of the π-phase shifted FBG 10, and a light wave that returns to the input/output end owing to reflection, at the sub-FBG 2 of the succeeding stage, of the light wave that has entered from the input/output end.

In order to implement this function, the difference

2[n₀(L_{g}+L₁)+δn₁L₁]

between the optical paths of the two reflected light waves is made (2k+1)/2 times the Bragg wavelength λ_{b} (where k is an integer).

For example, it is possible to finely adjust the difference between the optical paths by forming the core from a photosensitive resin and irradiating the core with ultraviolet light to adjust the optical-path length of each portion, or by forming the core from thermosensitive resin and heating the core to adjust the optical-path length of each portion.

Here L_{g} is the length of the gap, n₀ the refractive index of the gap, L₁ the length of the sub-FBG 1 and δn₁ the amount of modulation of the refractive index of the sub-FBG 1.

(2) The reflected light wave that returns to the input/output end owing to reflection at the sub-FBG 2 of the succeeding stage is delayed by a time Δt relative to the reflected light wave that returns to the input/output end upon being reflected by the sub-FBG 1. This time delay Δt between the reflected light waves of the sub-FBG 1 and sub-FBG 2 is smaller than the bit period T_{b} of an NRZ optical signal from which a clock signal is to be extracted.

The time delay Δt between the reflected light waves of the sub-FBG 1 and sub-FBG 2 is represented by the following equation:

Δt=2[n₀(L_{g}+L₁)+δn₁L₁]/c

where c is the velocity of light.

The time delay Δt is decided by the length L_{g} of the gap and the length L₁ of the sub-FBG 1 of the preceding stage; if these are made smaller, then the time delay Δt can be reduced. Further, a fine adjustment can be carried out by adjustment of optical-path length by irradiation with ultraviolet light or by application of heat, etc., as described above.

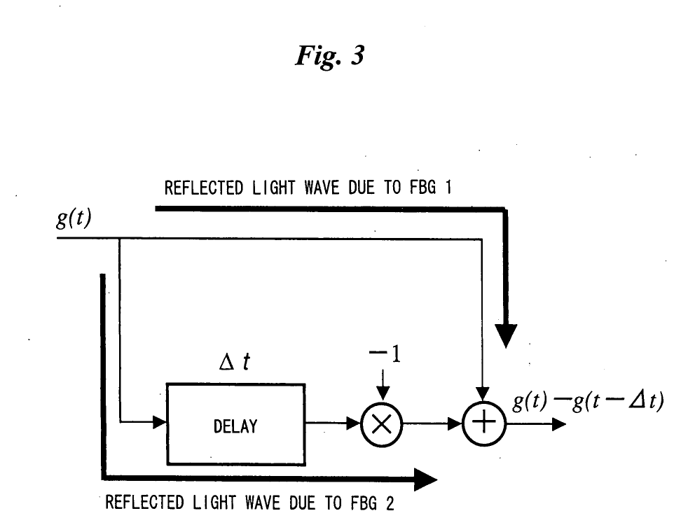

It can be understood that the π-phase shifted FBG having the two characterizing features set forth above has a function for implementing a light differential unit, as illustrated in FIG. 3.

In FIG. 3, g(t) represents the reflected light wave from the sub-FBG 1, g(t−Δt) represents the reflected light wave from the sub-FBG 2 having the delay time of Δt, and −1 represents the phase difference of π between the reflected light waves from the sub-FBG 1 and sub-FBG 2.

The resultant reflected light wave that is output from the π-phase shifted FBG 10 can be expressed as follows:

g(t)−g(t−Δt)

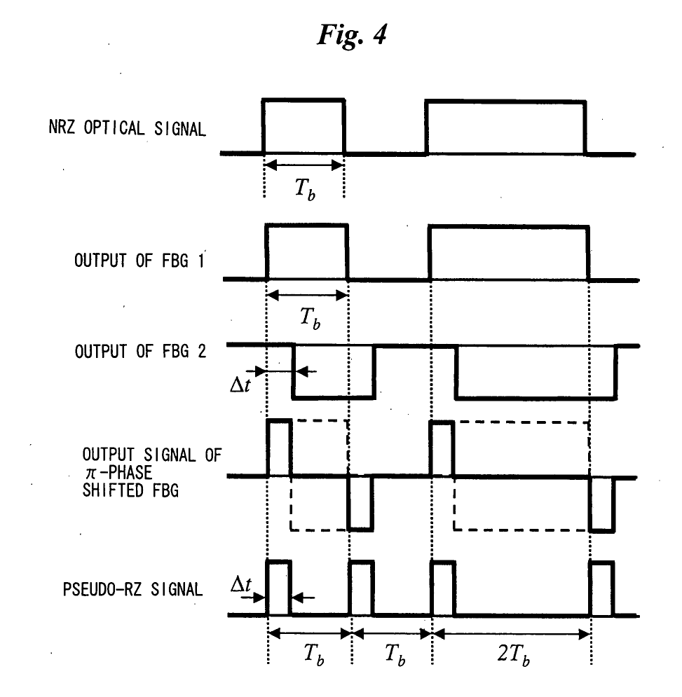

The structure and operation of the clock extraction apparatus shown in FIG. 1 will be described predicated on the foregoing with reference to the waveform diagram shown in FIG. 4. An optical signal (NRZ optical signal) from which a clock is to be extracted is introduced to the input/output end of the π-phase shifted FBG 10 through a light circulator 11. In the π-phase shifted FBG 10, as described above, a time delay (Δt) [smaller than the bit period (T_{b}) of the optical signal] and a phase difference of π are applied in the gap of the π-phase shifted FBG between reflected light of the sub-FBG 1 of the preceding stage and reflected light of the sub-FBG 2 of the succeeding stage. That is, the π-phase shifted FBG 10 functions as a differential unit. In the output optical signal (an optical signal that is the result of combining the two reflected light waves) obtained from the π-phase shifted FBG 10, the reflected light waves from the respective sub-FBGs interfere and cancel each other out in the temporally overlapping portions owing to the phase difference π between the reflected light waves. Light pulses having a pulse width corresponding to the time delay (Δt) and differing in phase by π appear at the rising edge and falling edge of the optical signal. For the sake of convenience, the light pulse whose phase differs by π is represented in FIG. 4 as a pulse having a negative amplitude.

The light pulse that is output from the π-phase shifted FBG 10 is applied to a photosensor 12 through the light circulator 11 and is converted to an electrical signal by the photosensor 12. As a result, there is obtained an electrical pulse signal (referred to as a “pseudo-RZ signal”) in which the positive and negative light pulses all have a positive amplitude. (The photosensor 12 has a function for squaring the absolute value of signal amplitude.) Since the pseudo-RZ signal has pulses at the positions of the rising and falling edges of the original optical signal (NRZ optical signal), the pulse interval is an integral multiple of the bit period (T_{b}) of the original optical signal (the minimum interval is T_{b}) and the signal has a strong clock component. The output signal of the photosensor 12 is applied to a narrow-band (high Q value) band-pass filter (BPF) 13 having a pass central frequency corresponding to the reciprocal (1/T_{b}) of the bit period T_{b}. The emphasized clock component of the output electrical signal (pseudo-RZ signal) from the photosensor 12 is extracted by the narrow-band filter 13. That is, an electrical clock signal is generated.

The output signal (inclusive of a wave-shaped signal) of the narrow-band filter 13 is used as a control signal of an optical modulator (the input to which is an optical signal of fixed amplitude), thereby enabling an optical clock signal to be obtained from the optical modulator.

Thus, in accordance with the apparatus shown in FIG. 1, it is possible through use of a simple arrangement to obtain a clock signal stronger than that obtained with the conventional technique. Further, if the time delay (Δt) is reduced by shortening the length L₁ of the sub-FBG 1 of the preceding stage or the length L_{g} of the gap in the π-phase shifted FBG 10, it is possible to support an optical signal of higher speed [of shorter bit period (T_{b})].

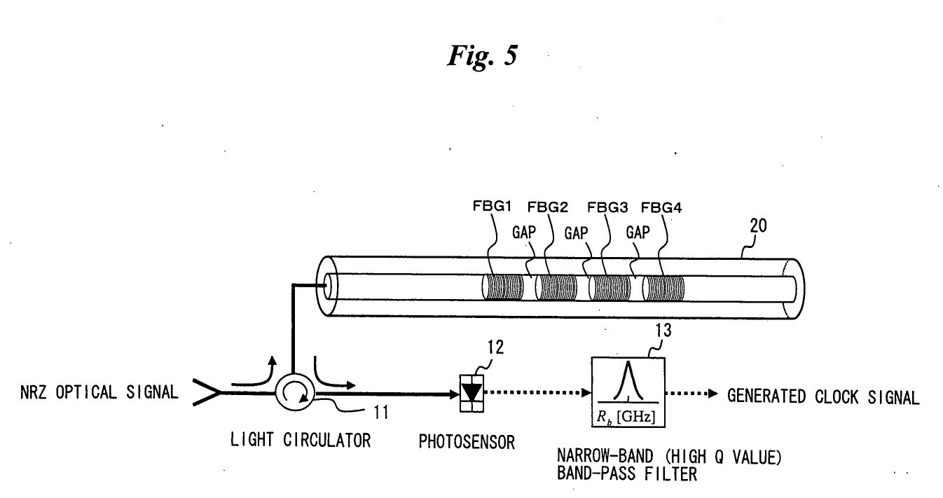

FIG. 5 illustrates the overall configuration of an apparatus according to a second embodiment for extracting (the term “generating” or “producing” may also be used) a clock signal from an NRZ optical signal.

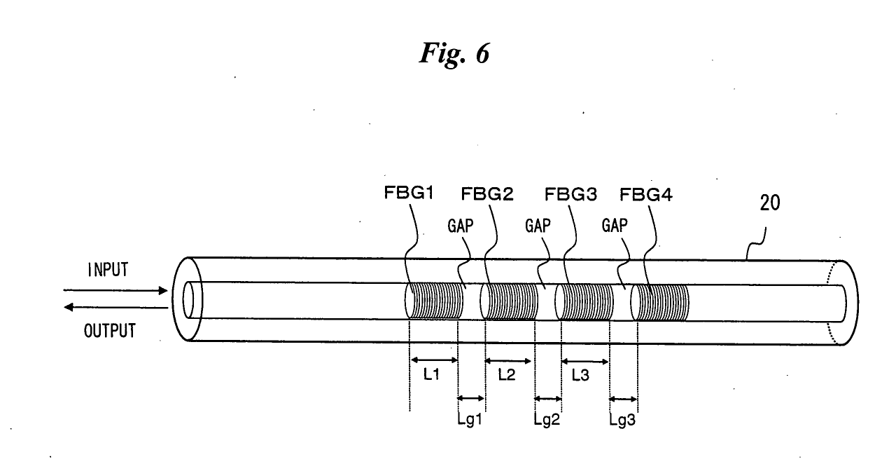

A low-reflectivity FBG-loaded π-phase shifted fiber Bragg grating 20 is an optical fiber comprising a core and a surrounding clad layer. As illustrated in the enlarged view of FIG. 6, a first sub-FBG 1, second FBG 2, third sub-FBG 3 and fourth sub-FBG are formed in the core of the optical fiber at positions slightly inward from the light input/output end. Gaps exist between mutually adjacent ones of these four sub-FBGs. The sub-FBG 1 to sub-FBG 4 are gratings (diffraction gratings) that are ascribable to a change in refractive index that produces Bragg diffraction.

In the low-reflectivity FBG-loaded π-phase shifted fiber Bragg grating 20, the four sub-FBGs, namely the first, second, third and fourth sub-FBGs, are disposed in the order mentioned and are adjusted in such a manner that reflectivities R1, R4 of the first sub-FBG 1 and fourth sub-FBG 4 will be less than reflectivities R2, R3 of the second sub-FBG 2 and third sub-FBG 3. For example, 2R1=R2=R3=2R4.

Further, an adjustment is made in such a manner that a phase difference between the reflected light waves of the first and second sub-FBGs, a phase difference between the reflected light waves of the second and third sub-FBGs and a phase difference between the reflected light waves of the third and fourth sub-FBGs will each be π and time delay Δt between the reflected light waves will be smaller than the bit period T_{b} of the optical signal from which the clock signal is to be extracted.

Preferably, among the four sub-Bragg gratings in the above-described low-reflectivity FBG-loaded π-phase FBG, the sum (L1+L_{g1}) of the optical-path length L1 of the first sub-FBG 1 and the optical-path length L_{g} of the gap delimited by the first sub-FBG 1 and second sub-FBG 2, the sum (L2+L_{g2}) of the optical-path length L2 of the second sub-FBG 2 and the optical-path length L_{g2} of the gap delimited by the second sub-FBG 2 and third sub-FBG 3 and the sum (L3+L_{g3}) of the optical-path length L3 of the third sub-FBG 3 and the optical-path length L_{g3} of the gap delimited by the third sub-FBG 3 and fourth sub-FBG 4 are adjusted in such a manner that the sum of time delays Δt between the reflected waves from two mutually adjacent sub-Bragg gratings will be smaller than the bit period T_{b} of the optical signal from which the clock signal is to be extracted.

That is, an adjustment is made in such a manner that the sum of the time delays ascribable to the optical-path length of the length (L1+L_{g1})+(L2+L_{g2})+(L3+L_{g3}) will be smaller than the bit period T_{b}. This can be expressed another way by saying that the temporal delay of the reflected light rays of sub-FBG 1 and sub-FBG 4 is smaller than T_{b}.

Preferably, among the four sub-FBGs, reflectivities R1, R4 of the first sub-FBG 1 and fourth sub-FBG 4 and reflectivities R2, R3 of the second sub-FBG 2 and third sub-FBG 3 are decided in such a manner that the intensities of the reflected light waves of the respective pair of two Bragg gratings will be substantially the same. That is, the reflectivities are decided in such a manner that R1=R4, R2=R3 will hold.

Preferably, the grating periods of the four sub-FBGs are decided in such a manner that the Bragg wavelengths of these four sub-FBGs will be substantially the same.

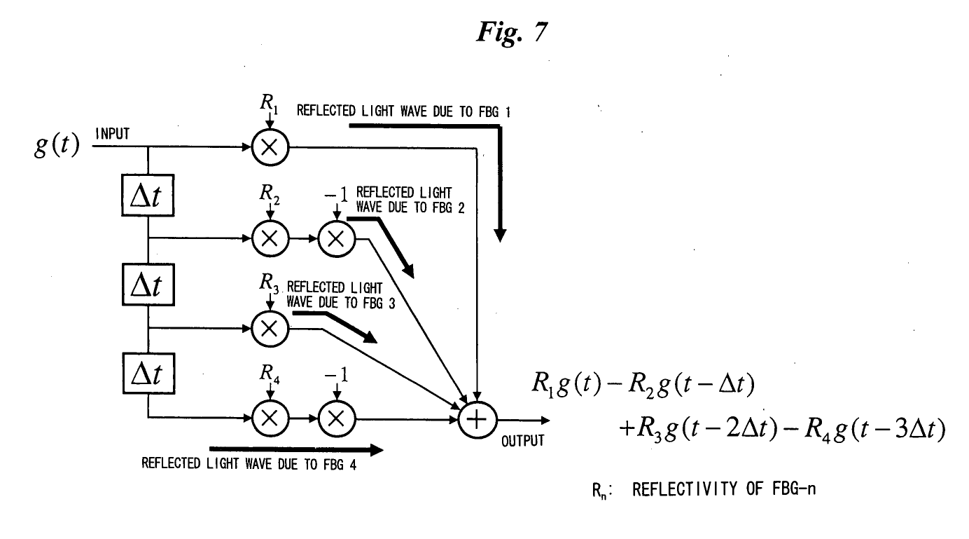

FIG. 7 illustrates an equivalent circuit of such a low-reflectivity FBG-loaded π-phase shifted FBG. If we let g(t) represent the input, then the output can be expressed by R₁g(t)−R₂g(t−Δt)+R₃g(t−2Δt)−R₄g(t−3Δt).

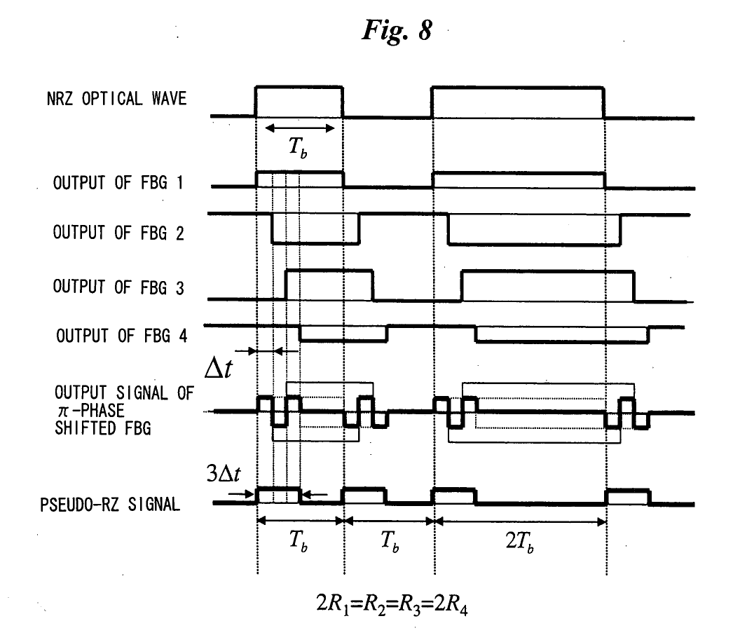

FIG. 8 illustrates the following signals when an NRZ light wave is input to the above-described low-reflectivity FBG-loaded π-phase shifted FBG 20: the output of the reflected light wave from sub-FBG 1, the output of the reflected light wave from sub-FBG 2, the output of the reflected light wave from sub-FBG 3, the output of the reflected light wave from sub-FBG 4, the resultant output from the low-reflectivity FBG-loaded π-phase shifted FBG 20 and the pseudo-RZ signal that is output from the photosensor 12.

The clock signal extraction apparatus of the second embodiment is such that in a case where a wavelength difference Δλ arises between the carrier wavelength of an optical signal from which a clock signal is to be extracted and the Bragg wavelength of a π-phase shifted Bragg grating, the wavelength difference Δλ that is allowable increases. Resistance to wavelength drift is improved.

The first embodiment is an example in which use is made of a π-phase shifted FBG having two sub-FBGs, and the second embodiment is an example in which use is made of a low-reflectivity FBG-loaded π-phase shifted FBG having four sub-FBGs.

In general, a clock extraction method according to the present invention using a π-phase shifted FBG having 2n-number (where n is a positive integer) of sub-FBGs is a method of extracting a clock signal from an optical signal and comprises: using a low-reflectivity Bragg grating-loaded π-phase shifted Bragg grating, which has 2n-number (where n is a positive integer) of sub-Bragg gratings (FBG 1, FBG 2, . . . , BG 2n) disposed in an optical waveguide with gaps interposed between them, these first, second, . . . , 2 nth) sub-Bragg gratings of 2n in number being arranged in the order mentioned, reflectivities (Rk, R2n−k+1) of kth (where k is a positive integer equal to or greater than 1 and less than n) and (2n−k+1)th sub-Bragg gratings (FBG k, FBG 2n−k+1) being set so as to be substantially equal, reflectivities of mth (where m is a positive integer equal to or greater than 1 and less than n−1) and (m+1)th sub-Bragg gratings being adjusted in such a manner that Rm<Rm+1 will hold, and an adjustment being made in such a manner that phase differences between the reflected light waves of the kth and (2n−k+1)th sub-Bragg gratings will each be π, the phase differences between the reflected light waves of the mth and (m+1)th sub-Bragg gratings will each be π, and amount of time delay Δt between the reflected light waves will be smaller than a bit period (T_{b}) of the optical signal from which the clock signal is to be extracted; guiding an optical signal from which a clock signal is to be extracted to the low-reflectivity Bragg grating-loaded π-phase shifted Bragg grating from the side of the first sub-Bragg grating, taking out a reflected light wave from the low-reflectivity Bragg grating-loaded π-phase shifted Bragg grating and converting the reflected light wave to an electrical signal; and obtaining a clock signal by passing this electrical signal into a narrow-band filter in which a frequency corresponding to the reciprocal of the bit period (T_{b}) of the optical signal is adopted as the pass central frequency.

A clock extraction apparatus according to the present invention is an apparatus for extracting a clock signal from an optical signal and comprises: a low-reflectivity Bragg grating-loaded π-phase shifted Bragg grating having 2n-number (where n is a positive integer) of sub-Bragg gratings (FBG 1, FBG 2, . . . , FBG 2n) disposed in an optical waveguide with gaps interposed between them, these first, second, . . . , 2 nth) sub-Bragg gratings of 2n in number being arranged in the order mentioned, reflectivities (Rk, R2n−k+1) of kth (where k is a positive integer equal to or greater than 1 and less than n) and (2n−k+1)th sub-Bragg gratings (FBG k, FBG 2n−k+1) being set so as to be substantially equal, reflectivities of mth (where m is a positive integer equal to or greater than 1 and less than n−1) and (m+1)th sub-Bragg gratings being adjusted in such a manner that Rm<Rm+1 will hold, and an adjustment being made in such a manner that phase differences between the reflected light waves of the kth and (2n−k+1)th sub-Bragg gratings will each be π, the phase differences between the reflected light waves of the mth and (m+1)th sub-Bragg gratings will each be π, and amount of time delay Δt between the reflected light waves will be smaller than a bit period (T_{b}) of the optical signal from which the clock signal is to be extracted; a light circulator for guiding an optical signal from which a clock signal is to be extracted to the low-reflectivity Bragg grating-loaded π-phase shifted Bragg grating from the side of the first sub-Bragg grating, and outputting a reflected light wave from the low-reflectivity Bragg grating-loaded π-phase shifted Bragg grating; a photosensor for converting the reflected light wave, which is output from the light circulator, to an electrical signal; and a narrow-band filter, which is connected to an output side of the photosensor, for adopting the reciprocal of the bit period (T_{b}) of the optical signal as the pass central frequency.

A low-reflectivity Bragg grating-loaded π-phase shifted Bragg grating apparatus according to the present invention has 2n-number (where n is a positive integer) of sub-Bragg gratings (FBG 1, FBG 2, . . . , FBG 2n) disposed in an optical waveguide with gaps interposed between them, these first, second, . . . , 2 nth) sub-Bragg gratings of 2n in number being arranged in the order mentioned, reflectivities (Rk, R2n−k+1) of kth (where k is a positive integer equal to or greater than 1 and less than n) and (2n−k+1)th sub-Bragg gratings (FBG k, FBG 2n−k+1) being set so as to be substantially equal, reflectivities of mth (where m is a positive integer equal to or greater than 1 and less than n−1) and (m+1)th sub-Bragg gratings being adjusted in such a manner that Rm<Rm+1 will hold, and adjustment being made in such a manner that phase differences between the reflected light waves of the kth and (2n−k+1)th sub-Bragg gratings will each be π, the phase differences between the reflected light waves of the mth and (m+1)th sub-Bragg gratings will each be π, and amount of time delay Δt between the reflected light waves will be smaller than a bit period (T_{b}) of the optical signal from which the clock signal is to be extracted.

1. A method of extracting a clock signal from an optical signal, comprising:
using a π-phase shifted Bragg grating, which has two Bragg gratings disposed in an optical waveguide with a gap interposed between them, adjusted in such a manner that a phase difference between reflected light waves resulting from the two Bragg gratings will be π and amount of time delay between the reflected light waves will be Δt;
guiding an optical signal from which a clock signal is to be extracted to the π-phase shifted Bragg grating, taking out a reflected light wave from the π-phase shifted Bragg grating and converting the reflected light wave to an electrical signal; and
obtaining a clock signal by passing this electrical signal into a narrow-band filter in which a frequency corresponding to the reciprocal of the bit period (T_{b}) of the optical signal is adopted as the pass central frequency.

2. An apparatus for extracting a clock signal from an optical signal, comprising:
a π-phase shifted Bragg grating, which has two Bragg gratings disposed in an optical waveguide with a gap interposed between them, adjusted in such a manner that a phase difference between reflected light waves resulting from the two Bragg gratings will be π and amount of time delay between the reflected light waves will be Δt;
a light circulator for guiding an optical signal from which a clock signal is to be extracted to said π-phase shifted Bragg grating and outputting a reflected light wave from said π-phase shifted Bragg grating;
a photosensor for converting the reflected light wave, which is output from said light circulator, to an electrical signal; and
a narrow-band filter, which is connected to an output side of said photosensor, for adopting a frequency corresponding to the reciprocal of the bit period (T_{b}) of the optical signal as the pass central frequency.

3. A π-phase shifted Bragg grating device used in order to extract a clock signal from an optical signal, said device having two Bragg gratings disposed in an optical waveguide with a gap interposed between them and being adjusted in such a manner that a phase difference between reflected light waves resulting from the two Bragg gratings will be π and amount of time delay between the reflected light waves will be Δt.

4. A method of extracting a clock signal from an optical signal, comprising:
using a low-reflectivity Bragg grating-loaded π-phase shifted Bragg grating, which has first, second, third and fourth sub-Bragg gratings (FBG 1, FBG 2, FBG 3, FBG 4) disposed in an optical waveguide with gaps interposed between them, these first, second, third and fourth sub-Bragg gratings being arranged in the order mentioned and reflectivities (R1, R4) of the first and fourth sub-Bragg gratings (FBG 1, FBG 4) being adjusted so as to be less than reflectivities (R2, R3) of the second and third sub-Bragg gratings (FBG 2, FBG 3), an adjustment being made in such a manner that a phase difference between the reflected light waves of the first and second sub-Bragg gratings, a phase difference between the reflected light waves of the second and third sub-Bragg gratings and a phase difference between the reflected light waves of the third and fourth sub-Bragg gratings will each be π and amount of time delay Δt between the reflected light waves will be smaller than a bit period (T_{b}) of the optical signal from which the clock signal is to be extracted;
guiding an optical signal from which a clock signal is to be extracted to the low-reflectivity Bragg grating-loaded π-phase shifted Bragg grating from the side of the first sub-Bragg grating, taking out a reflected light wave from the low-reflectivity Bragg grating-loaded π-phase shifted Bragg grating and converting the reflected light wave to an electrical signal; and
obtaining a clock signal by passing this electrical signal into a narrow-band filter in which a frequency corresponding to the reciprocal of the bit period (T_{b}) of the optical signal is adopted as the pass central frequency.

5. An apparatus for extracting a clock signal from an optical signal, comprising:
a low-reflectivity Bragg grating-loaded π-phase shifted Bragg grating, which has first, second, third and fourth sub-Bragg gratings (FBG 1, FBG 2, FBG 3, FBG 4) disposed in an optical waveguide with gaps interposed between them, these first, second, third and fourth sub-Bragg gratings being arranged in the order mentioned and reflectivities (R1, R4) of the first and fourth sub-Bragg gratings (FBG 1, FBG 4) being adjusted so as to be less than reflectivities (R2, R3) of the second and third sub-Bragg gratings (FBG 2, FBG 3), an adjustment being made in such a manner that a phase difference between the reflected light waves of the first and second sub-Bragg gratings, a phase difference between the reflected light waves of the second and third sub-Bragg gratings and a phase difference between the reflected light waves of the third and fourth sub-Bragg gratings will each be π and amount of time delay Δt between the reflected light waves will be smaller than a bit period (T_{b}) of the optical signal from which the clock signal is to be extracted;
a light circulator for guiding an optical signal from which a clock signal is to be extracted to said low-reflectivity Bragg grating-loaded π-phase shifted Bragg grating from the side of the first sub-Bragg grating, and outputting a reflected light wave from said low-reflectivity Bragg grating-loaded π-phase shifted Bragg grating;
a photosensor for converting the reflected light wave, which is output from said light circulator, to an electrical signal; and
a narrow-band filter, which is connected to an output side of said photosensor, for adopting a frequency corresponding to the reciprocal of the bit period (T_{b}) of the optical signal as the pass central frequency.

6. A low-reflectivity Bragg grating-loaded π-phase shifted Bragg grating device having first, second, third and fourth sub-Bragg gratings (FBG 1, FBG 2, FBG 3, FBG 4) disposed in an optical waveguide with gaps interposed between them, these first, second, third and fourth sub-Bragg gratings being arranged in the order mentioned and reflectivities (R1, R4) of said first and fourth sub-Bragg gratings (FBG 1, FBG 4) being adjusted so as to be less than reflectivities (R2, R3) of said second and third sub-Bragg gratings (FBG 2, FBG 3), and an adjustment being made in such a manner that a phase difference between the reflected light waves of said first and second sub-Bragg gratings, a phase difference between the reflected light waves of said second and third sub-Bragg gratings and a phase difference between the reflected light waves of said third and fourth sub-Bragg gratings will each be π and amount of time delay Δt between the reflected light waves will be smaller than a bit period T_{b} of the optical signal from which the clock signal is to be extracted.

7. A method of extracting a clock signal from an optical signal, comprising the steps of:
using a low-reflectivity Bragg grating-loaded π-phase shifted Bragg grating, which has 2n-number (where n is a positive integer) of sub-Bragg gratings (FBG 1, FBG 2, . . . , FBG 2n) disposed in an optical waveguide with gaps interposed between them, these first, second, 2 nth sub-Bragg gratings of 2n in number being arranged in the order mentioned, reflectivities (Rk, R2n−k+1) of kth (where k is a positive integer equal to or greater than 1 and less than n) and (2n−k+1)th sub-Bragg gratings (FBG k, FBG 2n−k+1) being set so as to be substantially equal, reflectivities of mth (where m is a positive integer equal to or greater than 1 and less than n−1) and (m+1)th sub-Bragg gratings being adjusted in such a manner that Rm<Rm+1 will hold, and an adjustment being made in such a manner that phase differences between the reflected light waves of the kth and (2n−k+1)th sub-Bragg gratings will each be a, the phase differences between the reflected light waves of the mth and (m+1)th sub-Bragg gratings will each be π, and amount of time delay Δt between the reflected light waves will be smaller than a bit period (T_{b}) of the optical signal from which the clock signal is to be extracted;
guiding an optical signal from which a clock signal is to be extracted to the low-reflectivity Bragg grating-loaded π-phase shifted Bragg grating from the side of the first sub-Bragg grating, taking out a reflected light wave from the low-reflectivity Bragg grating-loaded π-phase shifted Bragg grating and converting the reflected light wave to an electrical signal; and
obtaining a clock signal by passing this electrical signal into a narrow-band filter in which a frequency corresponding to the reciprocal of the bit period (T_{b}) of the optical signal is adopted as the pass central frequency.

8. An apparatus for extracting a clock signal from an optical signal, comprising:
a low-reflectivity Bragg grating-loaded π-phase shifted Bragg grating, which has 2n-number (where n is a positive integer) of sub-Bragg gratings (FBG 1, FBG 2, . . . , FBG 2n) disposed in an optical waveguide with gaps interposed between them, these first, second, . . . , 2 nth sub-Bragg gratings of 2n in number being arranged in the order mentioned, reflectivities (Rk, R2n−k+1) of kth (where k is a positive integer equal to or greater than 1 and less than n) and (2n−k+1)th sub-Bragg gratings (FBG k, FBG 2n−k+1) being set so as to be substantially equal, reflectivities of mth (where m is a positive integer equal to or greater than 1 and less than n−1) and (m+1)th sub-Bragg gratings being adjusted in such a manner that Rm<Rm+1 will hold, and an adjustment being made in such a manner that phase differences between the reflected light waves of the kth and (2n−k+1)th sub-Bragg gratings will each be π, the phase differences between the reflected light waves of the mth and (m+1)th sub-Bragg gratings will each be π, and amount of time delay Δt between the reflected light waves will be smaller than a bit period (T_{b}) of the optical signal from which the clock signal is to be extracted;
a light circulator for guiding an optical signal from which a clock signal is to be extracted to said low-reflectivity Bragg grating-loaded π-phase shifted Bragg grating from the side of the first sub-Bragg grating, and outputting a reflected light wave from said low-reflectivity Bragg grating-loaded π-phase shifted Bragg grating;
a photosensor for converting the reflected light wave, which is output from said light circulator, to an electrical signal; and
a narrow-band filter, which is connected to an output side of said photosensor, for adopting a frequency corresponding to the reciprocal of the bit period (T_{b}) of the optical signal as the pass central frequency.

9. A low-reflectivity Bragg grating-loaded π-phase shifted Bragg grating device having 2n-number (where n is a positive integer) of sub-Bragg gratings (FBG 1, FBG 2, . . . , FBG 2n) disposed in an optical waveguide with gaps interposed between them, these first, second, 2 nth sub-Bragg gratings of 2n in number being arranged in the order mentioned, reflectivities (Rk, R2n−k+1) of kth (where k is a positive integer equal to or greater than 1 and less than n) and (2n−k+1)th sub-Bragg gratings (FBG k, FBG 2n−k+1) being set so as to be substantially equal, reflectivities of mth (where m is a positive integer equal to or greater than 1 and less than n−1) and (m+1)th sub-Bragg gratings being adjusted in such a manner that Rm<Rm+1 will hold, and an adjustment being made in such a manner that phase differences between the reflected light waves of the kth and (2n−k+1)th sub-Bragg gratings will each be π, the phase differences between the reflected light waves of the mth and (m+1)th sub-Bragg gratings will each be π, and amount of time delay Δt between the reflected light waves will be smaller than a bit period (T_{b}) of the optical signal from which the clock signal is to be extracted.
